(19) United States
(12) Patent Application Publication
(10) Pub. No.: US 2011/0191984 A1
(43) Pub. Date: Aug. 11, 2011

(54) PANEL HINGE FOR A MOTOR VEHICLE

(75) Inventors: Dirk TIEMANN, Orbis (DE); Anett KILIAN, Trebur (DE); Michael MAAS, Schnorbach (DE); Matthias GRUNDHOEFER, Neustadt Weinstrasse (DE)

(73) Assignee: GM GLOBAL TECHNOLOGY OPERATIONS LLC, Detroit, MI (US)

(21) Appl. No.: 13/023,178

(22) Filed: Feb. 8, 2011

(30) Foreign Application Priority Data
Feb. 9, 2010 (DE) 102010007216.8

(51) Int. Cl. E05D 11/06; E05D 7/00

(52) U.S. Cl. 16/374; 16/382

(57) ABSTRACT

A panel hinge is provided for connecting a panel to a car body of a motor vehicle in an articulated fashion, which includes, but is not limited to a first hinge part for being mounted on the car body, a second hinge part for being mounted on the panel, a pivot bearing element that is connected to the first hinge part and about which the second hinge part can be pivoted. The second hinge part can be axially displaced, a clamping element that is rotatable about the pivot bearing element and can be clamped to the pivot bearing element. An axial position of the second hinge part can be fixed with the clamping element, and a first engaging element that is realized on one component, namely on the clamping element or the second hinge part, and engaged with a second engaging element that is realized on the other respective component in such a way that the clamping element is connected to the second hinge part in a rotationally rigid fashion. At least one of the two engaging elements is realized such that it is plastically deformed by the initial pivoting of the second hinge part in such a way that it is disengaged from the other engaging element.

### CROSS-REFERENCE TO RELATED APPLICATION

This application claims priority to German Patent Application No. 102010007216.8, filed Feb. 9, 2010, which is incorporated herein by reference in its entirety.

### TECHNICAL FIELD

The technical field is related to the field of automotive engineering and pertains to a panel hinge for connecting a panel to a car body of a motor vehicle in an articulated fashion.

### BACKGROUND

Panel hinges are used in many different ways in the industrial series production of motor vehicles. Many of these panel hinges already have been described in the relevant patent literature as well. In this respect, we refer, for example, to DE 10013726 C2 that describes a panel hinge with two stop components that are penetrated by a connecting element serving as a pivot pin. In one typical design of panel hinges for rear compartment hatches as they are also realized, for example, on vehicles of the applicant, one respective hinge is provided to both sides of the central longitudinal plane of the vehicle and a pivot bracket mounted on the rear compartment hatch is fixed on said hinge.

In view of the foregoing, at least one objective is to advantageously improve a conventional panel hinge for motor vehicles. In addition, other objectives, desirable features and characteristics will become apparent from the subsequent summary and detailed description, and the appended claims, taken in conjunction with the accompanying drawings and this background.

### SUMMARY

A panel hinge is provided for connecting a panel; particularly a rear compartment hatch such as a trunk lid, to a car body of a motor vehicle in an articulated fashion is disclosed. The panel hinge comprises a first hinge part for being mounted on the car body, a second hinge part for being mounted on the panel, as well as a pivot bearing element that is rigidly connected to the first hinge part and about which the second hinge part can be pivoted. In this case, the second hinge part is connected to the pivot bearing element in such a way that it can be displaced parallel to the pivoting axis (axially).

The panel hinge furthermore comprises a clamping element that is rotatable about the pivot bearing element and can be clamped to the pivot bearing element in a rotationally rigid fashion with the aid of a fastening means. In this case, the clamping element cooperates with the second hinge part in such a way that the second hinge part can be fixed in a freely selectable axial position by clamping the clamping element to the pivot bearing element.

In addition, a first engaging element is realized on one hinge component, namely either on the clamping element or the second hinge part, wherein the first engaging element is engaged with a second engaging element realized on the other respective hinge component in such a way that a rotational movement of the clamping element is blocked if it is not clamped to the pivot bearing element. Due to this measure, a rotationally rigid connection is produced between the clamping element and the second hinge part. In this case, at least one of the two engaging elements is realized such that it can be plastically deformed by the initial pivoting of the second hinge part about the pivot bearing element, namely in such a way that it is henceforth (permanently) disengaged from the other engaging element.

In the panel hinge, the ability to axially displace the second hinge part relative to the pivot bearing element makes it possible to axially position the panel that can be connected to the second hinge part relative to the pivot bearing element such that installation tolerances can be compensated. Due to the two engaging elements, a rotational movement of the (non-clamped) clamping element is blocked prior to the initial pivoting of the second hinge part such that the clamping element can be easily clamped in a certain rotational position relative to the pivot bearing element, for example, by manually actuating the fastening means. A rotational movement of the clamping element about the pivot bearing element that is otherwise caused by the actuation of the fastening means and makes it possible to impede or even prevent fixing of the clamping element therefore can be advantageously prevented such that the installation of the panel in the industrial series production is simplified.

In one embodiment of the panel hinge, the first engaging element is realized in the form of a locking element and the second engaging element is realized in the form of a recess for interlocking with the locking element, where the locking element is arranged, for example, on the clamping element and the recess is arranged in the second hinge part. The locking element may have, in particular, of a metallic material such as sheet steel and be realized in such a way that it is bent and disengaged from the recess during the initial pivoting of the second hinge part. This allows a particularly simple and cost-efficient realization in industrial series production.

In another embodiment of the panel hinge, the hinge part that features such a recess is also provided with a resetting element for plastically deforming the locking element, where the resetting element is realized such that the locking element is spaced apart from the hinge part featuring the recess (with the exception of the resetting element). In this embodiment, contact between the locking element and the hinge part featuring the recess is prevented after the initial pivoting of the second hinge part such that undesirable noise development during the pivoting of the panel can be prevented.

In order to prevent contact between the resetting element and the locking element in the preceding embodiment of the panel hinge, it may be provided with a stopping element for limiting the pivoting range of the second hinge part, where the stopping element is arranged in such a way that the pivoting range of the second hinge part does not include a segment, in which the resetting element and the locking elements can come in contact. Consequently, contact between the resetting element and the locking element that can be acoustically perceived, for example, in the form of scratching can be advantageously prevented.

In another embodiment of the panel hinge, the clamping element is realized in the form of a clamping part with two clamping arms, where a hinge part section of the second hinge part is axially arranged between the two clamping arms. Due to this measure, the second hinge part can be axially fixed in a technically simple and cost-effective fashion by clamping the clamping element to the pivot bearing element. The clamping part may consist, for example, of sheet steel and can be easily manufactured, for example, by being cut or punched out of a metal sheet and bent into a formed part.

In another embodiment of the panel hinge, the clamping element can be clamped to the pivot bearing element by means of a screw connection such that a simple option for producing the clamping joint between the clamping element and the pivot bearing part is created.

In another embodiment of the panel hinge, the second hinge part is realized in the form of a pivot bracket such that the panel hinge can be easily connected to the car body of the motor vehicle.

In another embodiment of the panel hinge, the first hinge part is realized in the form of two clamping jaws for clamping the pivot bearing element, wherein the two clamping jaws may be formed onto the car body, for example, in the form of sheet metal parts. This measure makes it possible to produce a particularly simple and cost-effective connection of the pivot bearing part with the car body, wherein the pivot bearing element is clamped between the two clamping jaws. In this case, it may be advantageous if the pivot bearing element is realized in the form of a hollow-cylindrical hinge tube that can be clamped with the aid of a fastening means that penetrates the two clamping jaws and the hinge tube. This makes it possible to easily and quickly produce the clamping joint. It may be particularly advantageous if the hinge tube that serves as pivot bearing element can be displaced perpendicular to the fastening means in order to create an option for compensating installation tolerances.

A motor vehicle is also provided with at least one above-described panel hinge. The motor vehicle may feature, in particular, two panel hinges that are arranged to both sides of the central longitudinal plane of the vehicle and serve for connecting a rear compartment hatch such as, for example, a trunk lid.

It goes without saying that the above-described embodiments may be realized individually or in arbitrary combinations without deviating from the scope as set forth by the claims.

### BRIEF DESCRIPTION OF THE DRAWINGS

The detailed description will hereinafter be made in conjunction with the following drawing figures, wherein like numerals denote like elements, and:

FIG. 1 shows a perspective representation of a rear car body section of a motor vehicle;

FIG. 2 shows an enlarged perspective representation of a panel hinge of the car body section according to FIG. 1; and

FIG. 3A-3B show perspective representations for elucidating the engaging elements of the panel hinge according to FIG. 2.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The figures show an exemplary embodiment in the form of a panel hinge for connecting a trunk lid to the car body of a motor vehicle that is identified as a whole by the reference symbol 1 in an articulated fashion. Only a rear car body section 2 of the motor vehicle is illustrated in figures. In accordance with the common directional terms used in vehicle construction, the longitudinal direction of the vehicle is indicated with “x,” the lateral direction of the vehicle is indicated with “y” and the vertical direction of the vehicle is indicated with “z.” The usual driving direction corresponds to the negative x-direction. Any other positional and directional terms used such as top, bottom, outside, inside, vertically and horizontally merely serve for simplifying the description of the invention in accordance with the illustration of the panel hinge in the figures and are not intended to restrict the invention in any way.

The motor vehicle 1 comprises two panel hinges 3 that are arranged to both sides of a central longitudinal plane of the vehicle and jointly serve for connecting a trunk lid 4. However, only the panel hinge 3 on the right side of the vehicle is illustrated in the figures in order to provide a better overview, where the left side of the vehicle may be accordingly realized symmetrically. The panel hinges on the left and the right side of the vehicle may nevertheless be realized identically. The car body section 2 is composed, for example, of sheet steel parts that are manufactured and welded together by means of conventional processes used in industrial series production. However, it would also be conceivable to manufacture at least a few components of other materials, particularly of light metals.

The two panel hinges 3 are arranged in the rear region of a cutout 6 for a rear window of the motor vehicle 1, namely on a car body crossbeam 5 (“rear window shelf”) that extends in the lateral direction (y) of the vehicle. The car body crossbeam 5 forms part of an end sheet that is identified as a whole by the reference symbol 7 and spatially separates a passenger compartment 8 from a trunk cavity that is not illustrated in detail in the figures and can be closed with the trunk lid 4.

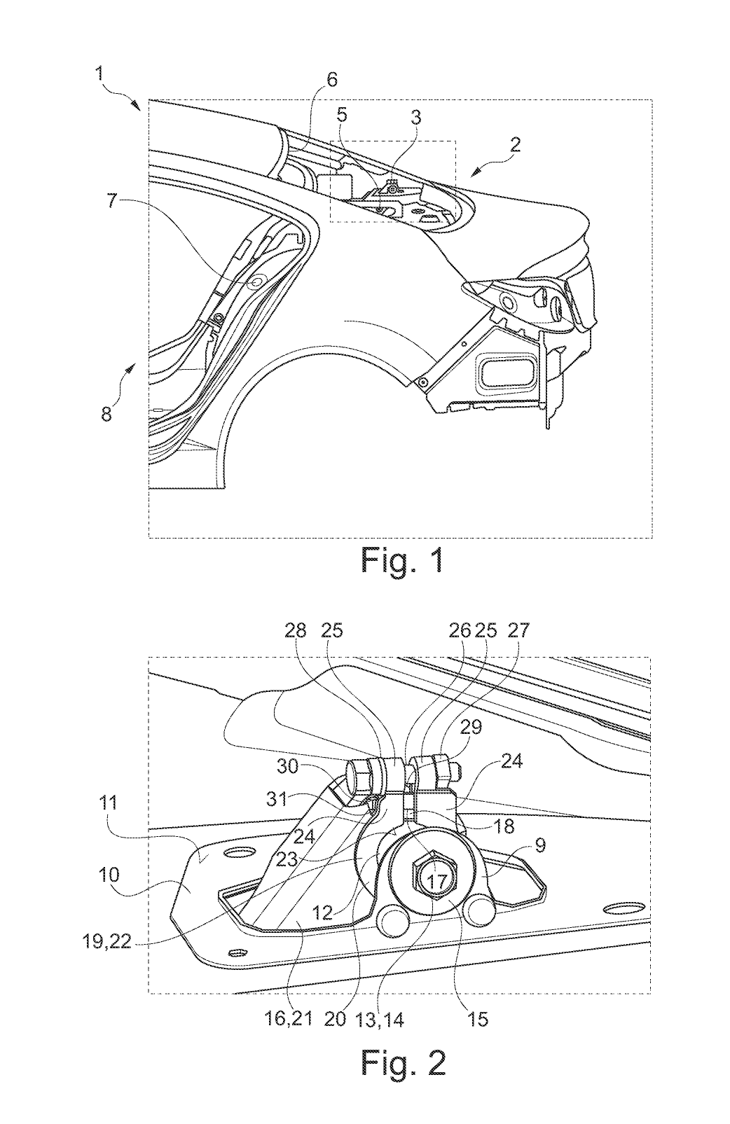

FIG. 2 shows an enlarged representation of the detail indicated in FIG. 1, wherein the panel hinge 3 comprises two clamping jaws 9 that consist of sheet metal and are formed onto a sheet metal insert part 10 of the car body crossbeam 5. For this purpose, a recess 11, on which two projections with approximately semicircular contour remain, is machined into the insert part 10, where the two clamping jaws 9 that are arranged opposite of one another referred to the lateral direction (y) of the vehicle are subsequently produced of these projections by means of bending.

The hollow-cylindrical hinge tube 12 that is arranged horizontally in the lateral direction (y) of the vehicle and serves as pivot bearing of the panel hinge 3 is clamped between the two clamping jaws 9 in a rotationally rigid fashion. For this purpose, the two clamping jaws 9 are respectively provided with a hole (not visible in the figures) that is penetrated by a screw that extends through the hinge tube 12 and is referred to as “clamping jaw screw 13” below. In addition, a washer 15 is provided and in contact with a screw head 14 of the clamping jaw screw 13. In order to produce a clamping joint, the clamping jaw screw 13 is screwed to a (not-shown) counter piece, wherein the clamping jaws 9 in the form of sheet metal parts can be deformed accordingly. Since the inside diameter of the hinge tube 12 is larger than the outside diameter of the clamping jaw screw 13, the hinge tube 12 can be positioned relative to the clamping jaw screw 13 in a freely selectable fashion perpendicular to the tube axis, i.e., in the x-direction and the z-direction, such that installation tolerances during the installation of the trunk lid 4 can be compensated.

A metallic pivot bracket 16 mounted on the trunk lid 4 protrudes through the recess 11 of the insert part 10 from below and encompasses the hinge tube 12, wherein the hinge tube 12 is accommodated in a round hole 17 of the pivot bracket 16 for this purpose. In order to prevent metal-to-metal contact, a sleeve 18 that consists, for example, of Teflon is arranged between the pivot bracket 16 and the hinge tube 12. The pivot bracket 16 can be pivoted about the hinge tube 12 in order to open and close the trunk lid 4, wherein a pivoting axis is defined by the symmetry axis of the hinge tube 12.

The pivot bracket 16 can be displaced along the hinge tube 12, i.e., in the lateral direction (y) of the vehicle, in a freely selectable fashion such that installation tolerances during the installation of the trunk lid 4 can be compensated. In order to fix a chosen axial position of the pivot bracket 16, a clamping part 19 is provided that encompasses a flat section 21 of the pivot bracket 16 from above with two vertical clamping arms 20. Referred to the lateral direction (y) of the vehicle or the axial direction, respectively, one clamping arm 20 is arranged on one side of the pivot bracket section 21 and the other clamping arm 20 is arranged on the other side of the pivot bracket section 21. Each clamping arm 20 features an open ring section 22 that encompasses the hinge tube 12 and features a circular opening 23, in which the hinge tube 12 is accommodated. The ring section 22 transforms into two oppositely arranged eye sections 24, between which an intermediate space 29 remains. Two oppositely arranged annular eyes 25 are formed onto the eye sections 24 of the two clamping arms 20 and penetrated by a screw that is referred to as “clamping part screw 26” below. The clamping part screw 26 is screwed to a nut 27 that is provided with a mating thread, wherein a screw head 28 is realized in the form of a polygon in order to attach a tool. The clamping part screw 26 extends in the longitudinal direction (x) of the vehicle in accordance with the alignment of the annular eyes 25 in the longitudinal direction (x) of the vehicle. The clamping part 19 can be fixed on the hinge tube 12 by tightening the clamping part screw 26 and reducing the size of the intermediate space 29 such that the pivot bracket 16 is axially fixed in both directions. However, the clamping part 19 can be turned about the hinge tube 12 if it is not fixed on the hinge tube 12.

The clamping part 19 can be easily manufactured by cutting or punching a blank of a metal sheet and suitably bending the blank, wherein this merely requires to bring the two clamping arms 20 into an opposite position and to likewise form the annular eyes 25 by means of bending. The installation of the panel hinge 3 may be realized, for example, by an initially positioning the clamping part 19 on the pivot bracket 16 and subsequently inserting the clamping jaw screw 13 through the clamping jaws 9, the clamping part 19 and the pivot bracket 16. The clamping jaw screw 13 and the clamping part screw 26 are tightened after the trunk lid 4 is suitably positioned.

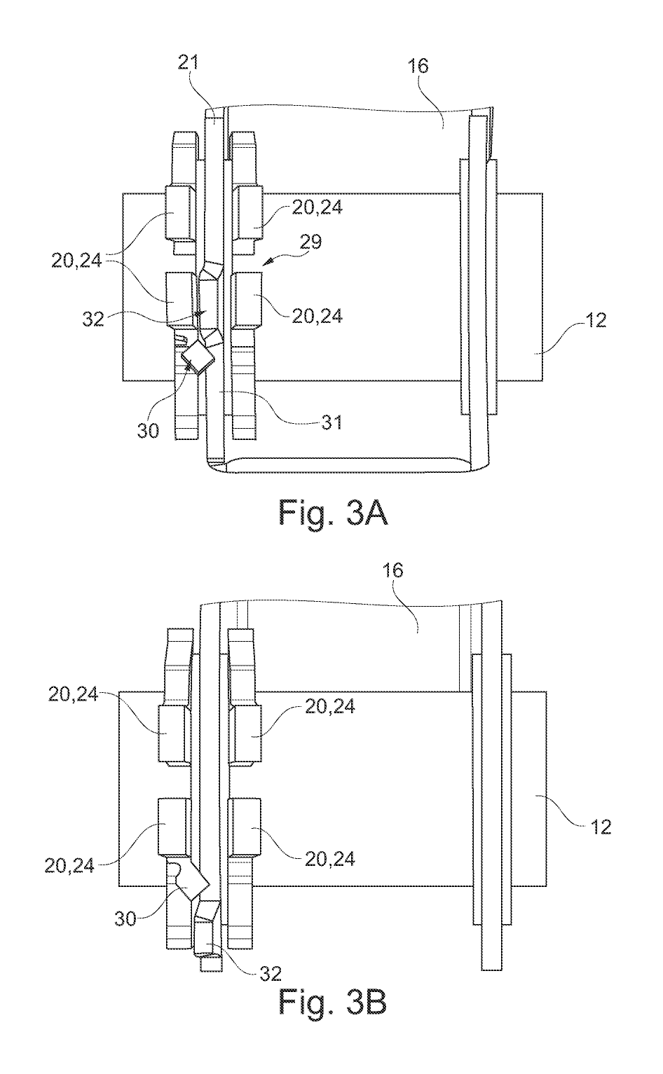

The following portion of the description refers to FIG. 3A and FIG. 3B that show perspective sectional representations of the (in contrast to FIG. 1 and FIG. 2 left) panel hinge 3. The sectional representations correspond to a horizontal plane of section at the height of the eye sections 24.

The description initially refers to FIG. 3A. According to this figure, the clamping part 19 of each panel hinge 3 comprises a latching tab 30 that is formed onto the inner clamping arm 20 and projects toward the pivot bracket section 21. The latching tab 30 can be easily manufactured by means of cutting and bending. In this case, the latching tab 30 engages, for example, positively into a recess 31 of the pivot bracket section 21 such that the rotational movement of the clamping part 19 about the hinge tube 12 is blocked. For this purpose, the recess 31 is arranged opposite of the latching tab 30 in a freely selectable position of the pivot bracket 16 that corresponds, for example, to a closed position of the trunk lid 4. The latching tab 30 that engages into the recess 31 advantageously makes it possible to prevent the clamping part 19 from turning about the hinge tube 12 when the clamping part screw 26 is tightened in order to clamp the clamping part 19 to the hinge tube 12. This significantly simplifies the fixing of the clamping part 19 and therefore the articulated connection of the trunk lid 4 with the car body section 2.

When the pivot bracket 16 is pivoted for the first time, for example, by transferring the trunk lid 4 from a closed position into an open position, the latching tab 30 is bent into a position, in which it no longer engages into the recess 31, by means of a resetting tab 32 of the pivot bracket section 21 that is realized, for example, in this case such that the rotationally rigid connection between the pivot bracket section 21 and the clamping part 19 is disengaged. For this purpose, the resetting tab 32 is slightly bent toward the inner clamping arm 20 such that no contact any longer exists between the latching tab 30 and the pivot bracket section 21 (with the exception of the resetting tab 32). This situation is illustrated in FIG. 3B. In order to prevent the latching tab 30 and the resetting tab 32 from contacting one another, it would be possible to additionally provide a stop for the pivot bracket 16 that limits the pivoting range of the pivot bracket 16 such that the latching tab 30 and the resetting tab 32 can no longer come in contact with one another. Such a stop can be installed after the initial pivoting of the pivot bracket 16 in order to decouple the latching tab 30 from the recess 31. However, this is not illustrated in the figures.

The embodiments are not limited to the concrete design of the exemplary embodiments. It should be noted, for example, that the clamping part could also be realized other than shown as long as an engagement between the clamping part and the pivot bracket prevents the clamping part from turning when it is fixed on the hinge tube. The engagement may also be realized other than shown as long as a rotationally rigid connection between the clamping part and the pivot bracket is produced and this connection can be disengaged by the initial pivoting of the pivot bracket. Morevoer, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A panel hinge for connecting a panel to a body of a motor vehicle in an articulated fashion, comprising:
a first hinge part configured for mounting on the body;
a second hinge part configured for mounted on the panel and for axial displacement;
a pivot bearing element configured to connect to the first hinge part and the second hinge part is configured to pivot about the pivot bearing element;
a clamping element configured to rotate about the pivot bearing element and configured to clamp to the pivot bearing element, wherein an axial position of the second hinge part can be fixed with the clamping element; and
a first engaging element on a component and engaged with a second engaging element on a second component such that the clamping element is connected to the second hinge part in a rotationally rigid fashion,
wherein the first engaging element is plastically deformed by an initial pivoting of the second hinge part and disengages from the second engaging element.

2. The panel hinge according to claim 1, wherein the component is the clamping element.

3. The panel hinge according to claim 1, wherein the component is the second hinge part.

4. The panel hinge according to claim 1, wherein the first engaging element is a latching element and the second engaging element is a recess.

5. The panel hinge according to claim 4, wherein the latching element is on the clamping element and the recess is in the second hinge part.

6. The panel hinge according to claim 4, wherein the latching element comprises a metallic material that is bent and disengaged from the recess during the initial pivoting of the second hinge part.

7. The panel hinge according to one of claim 4,
wherein the recess comprises a resetting element configured to plastically deform the latching element, and
wherein said resetting element is configured such that the latching element is deformed and spaced apart from the first hinge part with an exception of the resetting element.

8. The panel hinge according to claim 7, further comprising a stopping element configured to limit a pivoting range of the second hinge part,
wherein the stopping element is configured such that the pivoting range of the second hinge part does not include a segment in which the latching element and the resetting element can come in contact with one another.

9. The panel hinge according to claim 1,
wherein the clamping element is a clamping part with two clamping arms, and
wherein a section of the second hinge part is axially arranged between the two clamping arms.

10. The panel hinge according to claim 9, wherein the clamping part is configured to clamp to the pivot bearing element with a screw connection.

11. The panel hinge according to claim 1, wherein the second hinge part is a pivot bracket.

12. The panel hinge according to claim 1, wherein the first hinge part is two clamping jaws configured to clamp the pivot bearing element.

13. The panel hinge according to claim 12, wherein the two clamping jaws are formed onto the body in a form of sheet metal parts.

14. The panel hinge according to claim 12, wherein the pivot bearing element is a hinge tube.

15. The panel hinge according to claim 14, wherein the hinge tube is configured to clamp with an aid of a fastener that penetrates the two clamping jaws and the hinge tube.

16. The panel hinge according to claim 15, wherein the hinge tube is configured to displace perpendicularly to the fastener.
